(19) United States
(12) Patent Application Publication
(10) Pub. No.: US 2017/0123604 A1
(43) Pub. Date: May 4, 2017

(54) ENHANCED GROUP DISCOVERY

(71) Applicant: Microsoft Technology Licensing, LLC, Redmond, WA (US)

(72) Inventors: Vikram Kone, Bellevue, WA (US); Chung Heong Gooi, Redmond, WA (US); Warren Johnson, Sammamish, WA (US)

(21) Appl. No.: 14/931,117

(22) Filed: Nov. 3, 2015

(51) Int. Cl. G06F 3/0482; G06T 11/20

(52) U.S. Cl. CPC G06F 3/0482; G06T 11/206

(57) ABSTRACT

Technology is disclosed herein that enhances organizational search capabilities. In an implementation, a representation of an organization graph that is associated with a user is surfaced in a user interface to an organization search application. A node in the organization graph may be selected, which may correspond to a particular person or other such entity in the graph. A set of groups may be associated with the node from which a subset may be identified as potential groups to be suggested to the user. Group suggestions may be surfaced in the user interface to the user that represent the subset of groups, thereby enhancing group discovery within an organization.

### TECHNICAL BACKGROUND

Users in a variety of organizations, from commercial enterprises to neighborhood associations, often find it difficult to discover how other users in their organization relate, communicate, or otherwise interact. As an example, a business leader in a sales organization may desire visibility into the communication patterns of the people in her organization. Various information technology tools exist for examining such relationships, including organization graphs and their associated software.

An organization graph is a type of data structure in which the relationships between people and information can be expressed in terms of nodes and edges. A node in an organization graph may represent a person or a document, for example. An edge might then represent how a person relates to another person, to a document, or to another type of node. The organization graph may be traversed programmatically to answer queries about the relationships between the nodes in an organization.

Many organizations utilize other information technology tools that support the concept of groups in the context of email solutions, instant messaging services, microblogs, and other types of communication platforms. In the case of email, a user may join, subscribe to, or otherwise associated with a group. The user and others in the group may then email each other through the group identity, rather than having to communicate individually with each recipient. A user might seek out and associate with a given group in order to participate in an exchange of ideas and to receive relevant information in an elegant and efficient manner.

### OVERVIEW

Technology is disclosed herein that enhances organizational search capabilities. In an implementation, a representation of an organization graph that is associated with a user is surfaced in a user interface to an organization search application. A node in the organization graph may be selected, which may correspond to a particular person or other such entity in the graph. A set of groups may be associated with the node from which a subset may be identified as potential groups to be suggested to the user. Group suggestions may be surfaced in the user interface to the user that represent the subset of groups, thereby enhancing group discovery within an organization. In some implementations, content may also be identified and suggested in the user interface.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture and associated operational scenario in which enhanced organization search technology may be presented.

FIG. 2 illustrates an organization search process in an implementation.

FIG. 3 illustrates an organization search process in an implementation.

FIG. 4 illustrates an operational architecture in an implementation of enhanced organization search technology.

FIG. 5 illustrates an operational scenario in an implementation.

FIG. 6 illustrates an operational scenario in an implementation.

FIG. 7 illustrates an operational scenario in an implementation.

FIG. 8 illustrates a computing system suitable for implementing any of the architectures, processes, and operational scenarios disclosed herein with respect to the Figures and discussed below in the Technical Disclosure.

### TECHNICAL DISCLOSURE

Technology is disclosed herein for enhancing group discovery via organization graph search. In an implementation, at least a portion of an organization graph (or a visual representation thereof) is displayed in a user interface provided by an organization search application. The graph includes various edges and nodes that together express relationships between people and possibly other entities in an organization.

To improve the discovery of groups, content, and other characteristics of the organization, a user may navigate the representation of the graph via user input. Selecting a given node in the graph results in the display of a suggested group, content or the like. The user may select one of the suggestions to view, join, or otherwise further explore the group or content suggested in the user interface.

A technical effect provided by such a solution includes the capability for an end-user to quickly and more easily identify groups and content of interest. Such capabilities mitigate the time required to manually find groups and content of interest. In addition, by allowing a user to select a node of interest in an organization graph, the scope of a search for relevant groups and content to suggest may be narrowed, thereby reducing the computational complexity and processing resources required of such a task. Other technical effects are possible and may be considered within the scope of the present disclosure.

In various implementations, the enhanced organization search technology disclosed herein surfaces groups, conversations, content, and other information that may be of interest to a user, as the user navigates over a visual representation of a social graph, referred to herein as an organization graph. Viewing a graph allows an organization leader to, for example, investigate whether or not the people in his or her group are sharing information effectively, communicating with each other regularly, and gaining exposure to people and information outside of their part of the organization. Groups, content, and conversations can be surfaced to any user at any level to help that user achieve more connectedness and information awareness.

In a brief example of the technology, an organization graph is built that models the email relationships between people on a team in an organization. The graph may examine only the email relationships at the team level but could be expanded to represent the email relationships at any level throughout the organization. For example, a user could navigate to an individual view of the graph (how an individual is related by email to others in the organization or on the team), to a group level view of the graph (how sub-groups in the organization relate by email), or to some other delineating view.

The end-user is presented with a visual representation of the graph and can “click-thru” its various nodes and edges to explore the individuals in the graph and their content. For example, clicking on or otherwise selecting one user might reveal the email groups and other content feeds that the user subscribes to. When a representation of a group is surfaced (in response to a selection of a node), the end-user can select the representation to surface information, features, and functionality related to that group.

Group suggestions may be surfaced in response to navigating to individual nodes in the graph or simply when experiencing a particular view of the graph. For instance, when viewing the graph at a team level, group suggestions associated with the team may be surfaced in the user interface, irrespective of whether or not an individual node is selected. Such a capability provides managers with insight into what groups team members are participating in and gives team members visibility into other potentially valuable groups.

Groups can be previewed from a view of the graph without having to join them. A details page may be surfaced in association with a particular group that provides conversational topics, the contents of threads, and even suggested documents to allow an end-user to learn about the group before joining Other types of group-related information can be surfaced and may be considered within the scope of the present disclosure.

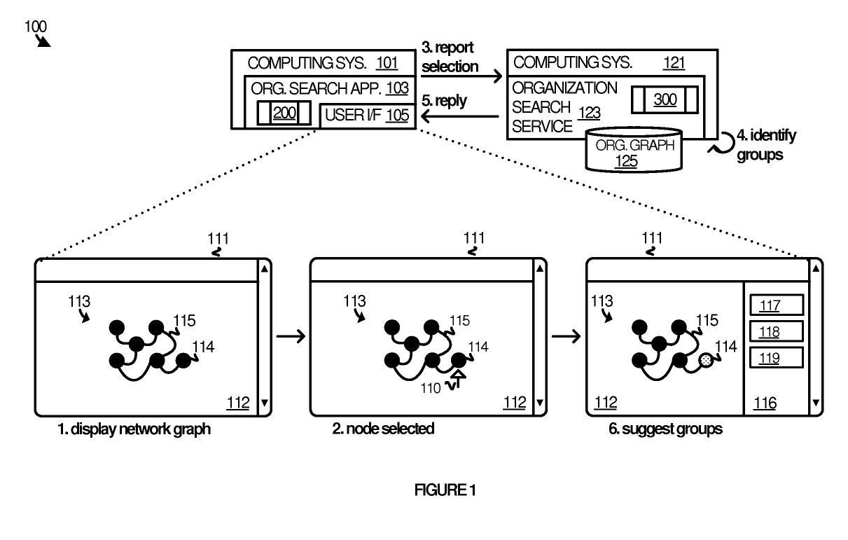

Referring to the drawings, FIG. 1 illustrates an operational architecture 100 for implementing enhanced organization search technology. Operational architecture 100 includes computing system 101 and computing system 121. Computing system 101 hosts an organization search application 103, with which an end-user may interact via user interface 105. Organization search application 103 communicates with organization search service 123 hosted on computing system 121. Operational architecture 100 also includes organization graph 125 which may be accessed indirectly or directly by organization search service 123.

In operation, organization search application 103 renders a view 111 in user interface 105. The view 111 includes a canvas 112 on which a representation 113 of organization graph 125 may be presented. Organization graph 125 is a data structure that contains information descriptive of how entities such as people and documents may related to each other. As such, representation 113 may include only a subset of the various relationships inherent to organization graph 125. For example, representation 113 may represent the organization graph for a specific user in an organization, for a specific set of users within an organization, for a specific level within an organization, or for some other delineation within the organization. The representation 113 of the organization graph 125 can be tailored as narrowly or broadly as needed (respecting privacy and security constraints).

In this example, the representation 113 of the organization graph includes nodes (e.g. node 114) and edges (e.g. edge 115). A user interacting with organization search application 103 through user interface 105 may make a selection 110 of a particular node. The selection may be made via a touch, a mouse click, a spoken command, or any other type of user input. Organization search application 103 reports the selection to organization search service 123, which can then proceed to identify group suggestions.

Organization search service 123 interfaces with organization graph 125 to identify the group suggestions. Assuming node 114 represents a person in the graph, organization search service 123 may query organization graph 125 for groups associated with the person. The set of groups that are returned may be further filtered by organization search service 123 to identify a subset based on their relevance to the selected node, the end-user, or both. The results are returned to organization search application 103 which then presents them in a panel 116. The suggested groups are represented by element 117, element 118, and element 119. Elements 117, 118, and 119 may be relatively simple graphical representations of the suggested groups, such as text boxes with the name of each group included therein. However, in some implementations the elements may be more interactive such that the end-user can select them in order to obtain additional information about a group, join the group, and view the group's graph, or take any other suitable action.

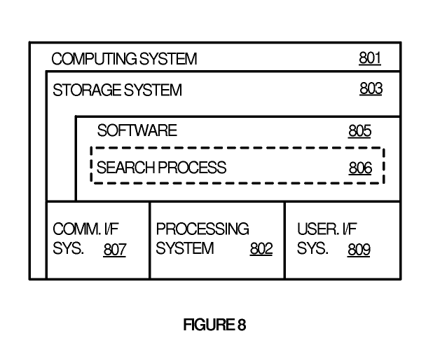

Computing system 101 is representative of any physical or virtual computing system (or systems) capable of hosting organization search application 103, of which computing system 801 in FIG. 8 is representative. Examples include, but are not limited to, desktop computers, notebooks computers, laptop computers, tablet computers, mobile phones, smart-phones, wearable devices, phablet devices, virtual machines, and containers, as well as any other type of computing device.

Organization search application 103 is representative of any software application, application component, or collection thereof capable of implementing organization search process 200. Organization search application 103 may be a stand-alone application or may be integrated in the context of another application or applications. In addition, organization search application 103 may be implemented as a native application, a web-application that runs in the context of a browser, a mobile application, a streamed or streaming application, or any other type of application.

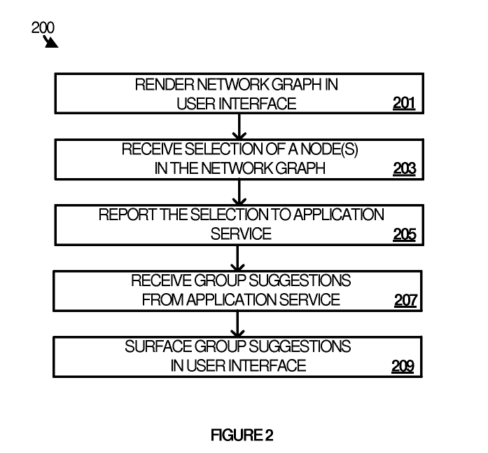

Organization search process 200 may be implemented in program instructions that, when executed by a suitable processing system, carry out the functional steps illustrated in FIG. 2. Referring parenthetically to the steps in FIG. 2, when employing organization search process 200, an organization search application renders an organization graph in a user interface for consumption by a user (step 201). The user may select a particular node in the graph, the selection of which is received by the application (step 203). The application reports the selection to a remote service, such as an organization search service (step 205), and receives group suggestions returned by the search (step 207). The suggestions may then be surfaced by the application in its user interface (step 209) for the user to consider.

Computing system 121 is representative of any physical or virtual computing system (or systems) capable of hosting organization search service 123, of which computing system 801 in FIG. 8 is representative. Examples include, but are not limited to server computers (physical or virtual), rack servers, containers, and any other suitable device.

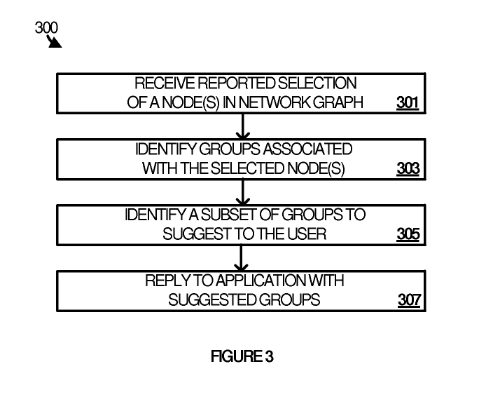

Organization search service 123 is representative of any software service or services capable of implementing organization search process 300. Organization search service 123 may be a stand-alone service or may be integrated in the context of another service. Organization search process 300 may be implemented in program instructions that, when executed by a suitable processing system, carry out the functional steps illustrated in FIG. 3. In some implementations, organization search service 123 may be implemented in a data center environment (physical or virtual) in what is sometimes referred to as the cloud.

Referring parenthetically to the steps in FIG. 3, when employing organization search process 300, an organization search service receives a reported selection of a node (or nodes) made by a user in an organization graph (step 301). The service identifies groups associated with the selected node (step 303) and then identifies a subset of the groups to provide as suggestions (step 305). The set of groups may be any or all groups associated with the node. For example, the selected node may be associated with a quantity of email groups or other types of associations. The subset may be selected from the set based on the relevance of each group to either the node, the user, or both. Having identified the subset of groups, the service may respond to an application with suggestions to be rendered in a user interface to the application (step 307).

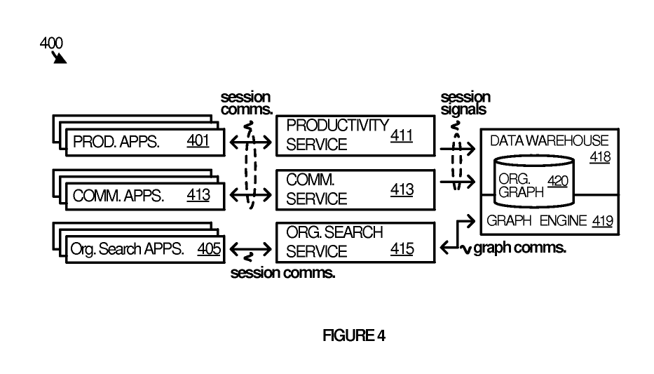

FIG. 4 illustrates another operational architecture in an implementation, operational architecture 400. Operational architecture 400 includes productivity applications 401 which communicate with productivity service 411. Communication applications 403 communicate with communication service 413. In the background, productivity service 411 and communication service 413 both communicate with data warehouse 418.

Operational architecture 400 also includes organization search applications 405 and organization search service 415. Organization search service 415 communicates with graph engine 419. Graph engine 419 operates on organization graph 420.

In operation, end-users utilize productivity applications 401 to perform work, such as the creation and editing of documents, spreadsheets, presentations, and other types of productivity content, as well as creating, sending, and receiving email. Productivity applications 401 may be native applications, web-applications that run in the context of a browser, mobile applications, streamed (or streaming) applications, or any other type of productivity application. Productivity services 411 represent the services that correspond to the productivity applications. Examples include, but are not limited to, word processing and spreadsheet application services, email services, file storage services, presentation services, and any other type of productivity service.

The end-users may also utilize communication applications 403 to perform work and to otherwise interact with other end-users. Examples of communication application 403 include real-time voice calling applications, video conferencing applications, and instant messaging applications. Communication service 413 include the services corresponding to the communication applications, such as voice and video calling platforms, instant messaging services, and the like.

Productivity service 411 and communication service 413 exchange session communications with productivity applications 401 and communication applications 403 in the context of productivity and communication sessions engaged in by the end-users. In addition, the services communicate with data warehouse 418 to providing signaling used to construct and populate organization graph 420. The signaling may describe, for example, the operations engaged in by the end-users, such as: creating, sharing, and reviewing documents; sending and receiving email; messaging each other; speaking with each other; and all the other various ways users may interact. Organization graph 420 may therefore include edges and nodes that model the real-life interaction of the organization's users.

Organization search service 415 interfaces with graph engine 419 in order to query organization graph 420 for useful information. Graph engine 419 provides the capability to traverse organization graph 420 in response to queries or other requests submitted by organization search service 415. End-users may experience organization graph 420 (or its subsets) through organization search applications 405 that interface with organization search service 415. Microsoft® Delve® is one example of an organization search service and application pairing.

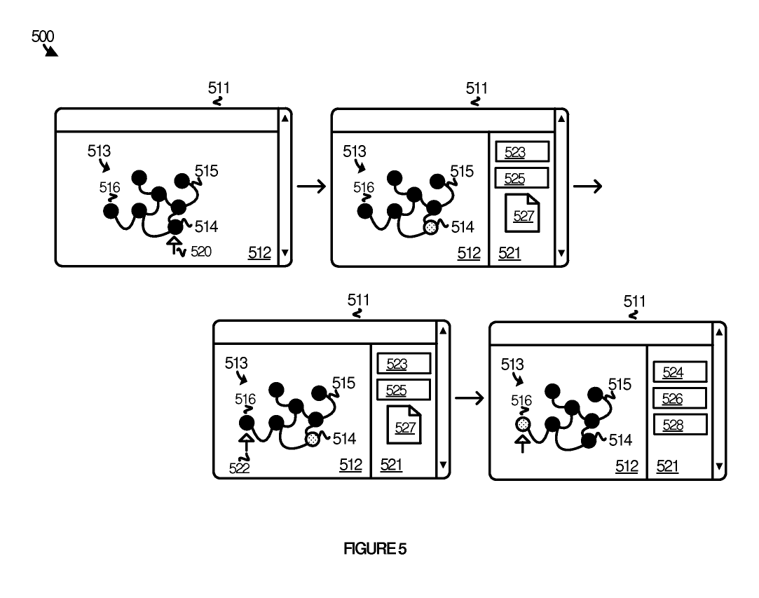

FIG. 5 illustrates an operational scenario 500 that demonstrates some of the capabilities of the organization search applications shown in FIG. 4. Operational scenario 500 involves a view 511 rendered in a user interface to an organization search application. View 511 includes (initially) a canvas 512 on which a representation 513 of a graph may be presented. The representation 513 of the graph includes various edges and nodes; for example edge 515 and nodes 514 and 516.

A user interacting with the user interface may make a selection 520 of a given node, node 514 in this example. The selection 520 may be a touch, a mouse click, a spoken command, or some other type of user input. The selection 520 prompts the application to communicate with an organization search service (e.g. organization search service 415), which returns relevant groups and content to suggest to the user.

In this example, the application renders panel 521 and representations of the suggested groups and content. Element 523 and element 525 are graphical representations of suggested groups, while icon 527 represents suggested content, such as a document, spreadsheet, photo, or other types of content.

The user may then proceed to make another selection (selection 522) of a different node (node 516). The second selection drives the application to retrieve another set of suggested groups and/or content from the organization search service. In this example, node 514 is no longer the active node. Rather, node 516 becomes the active node. New suggestions are provided in panel 521 that correspond to the newly active node. Thus, panel 521 includes element 524, element 526, and element 528, which each represent a potential group that is being suggested to the end-user.

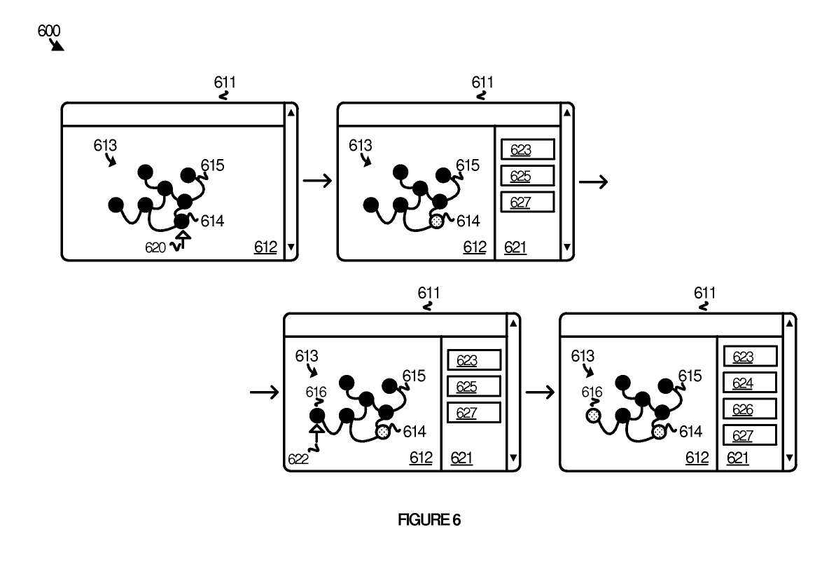

FIG. 6 illustrates operational scenario 600 in an implementation to demonstrate additional capabilities of the organization search applications shown in FIG. 4. Operational scenario 600 involves a view 611 rendered in a user interface to an organization search application. View 611 includes (initially) a canvas 612 on which a representation 613 of a graph may be presented. The representation 613 of the graph includes various edges and nodes; for example edge 615 and nodes 614 and 616.

A user interacting with the user interface may make a selection 620 of a given node, node 614 in this example. The selection 620 may be a touch, a mouse click, a spoken command, or some other type of user input. The selection 620 prompts the application to communicate with an organization search service (e.g. organization search service 415), which returns relevant groups and content to suggest to the user. In this example, the application renders panel 621 and representations of the suggested groups and content. Elements 623, 625, and 627 are graphical representations of suggested groups.

The user may then proceed to make another selection (selection 622) of a different node (node 616). The second selection drives the application to retrieve another set of suggested groups and/or content from the organization search service that is a blend of groups associated with both active nodes. In this example, node 614 remains an active node and node 616 becomes active, too. A blend of suggestions are provided in panel 621 that correspond to the newly active node and to the other active node. Thus, panel 621 includes element 623, element 624, element 626, and element 627, each corresponding to a group being suggested to the end-user. It may be appreciated that content could also be suggested to the end-user in operational scenario 600.

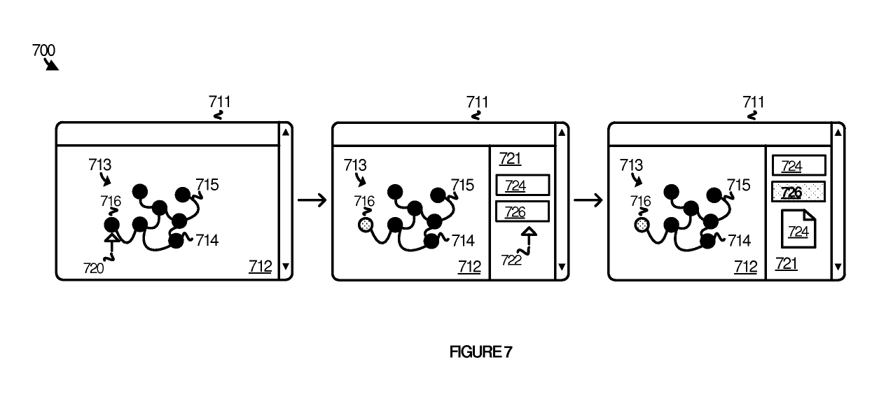

FIG. 7 illustrates another scenario, operational scenario 700, in an implementation to further demonstrate capabilities of the organization search applications shown in FIG. 4. Operational scenario 700 involves a view 711 rendered in a user interface to an organization search application. View 711 includes canvas 712 on which a representation 713 of a graph may be presented. The representation 713 of the graph includes various edges and nodes; for example edge 715 and nodes 714 and 716.

A user interacting with the user interface may make a selection 720 of a given node, node 716 in this example. The selection 720 may be a touch, a mouse click, a spoken command, or some other type of user input. The selection 720 prompts the application to communicate with an organization search service (e.g. organization search service 415), which returns relevant groups and content to suggest to the user. In this example, the application renders panel 721 and representations of the suggested groups and content. Elements 724 and 726 are graphical representations of the suggested groups.

The user may then proceed to make another selection (selection 722) of one of the suggested groups by way of element 726. The second selection drives the application to retrieve a content suggestion from the organization search service. Icon 724 is rendered in panel 721 and corresponds to the content suggestion.

In some implementations, various factors may be evaluated when determining which groups and what content to suggest to an end-user. For instance, the proximity in terms of segments between any two nodes in a graph, as well as the communication habits and content subscriptions expressed in a graph may be factors. A proximal statistical likelihood (e.g. through inference) that data/content actively being consumed by a neighbor (with proximity determined by total number segments in the graph from one node to the next) can be calculated to assist with determining whether or not a group or content will have value if suggested. Going one layer further it is also possible to “look within” publically accessible (non-protected/non-private) containers like groups or even meetings to score the content contained in them (e.g. email “threads”) for likelihood of relevance to the current end-user and then recommend the conversations to the end user.

FIG. 8 illustrates computing system 801 that is representative of any system or collection of systems in which the various operational architectures, scenarios, and processes disclosed herein may be implemented. Examples of computing system 801 include, but are not limited to, smart phones, laptop computers, tablet computers, desktop computers, hybrid computers, gaming machines, virtual machines, smart televisions, smart watches and other wearable devices, as well as any variation or combination thereof. Other examples include server computers, rack servers, web servers, cloud computing platforms, and data center equipment, as well as any other type of physical or virtual server machine, container, and any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes search process 806, which is representative of the organization search processes discussed with respect to the preceding Figures, including organization search process 200 and organization search process 300.

When executed by processing system 802 to enhance organization search capabilities, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. For example, software 805 may include program instructions for implementing enhanced organization search and group suggestion.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software or other application software, in addition to or that include search process 806. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to facilitate enhanced organization search. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

Example 1. A computing apparatus comprising: one or more computer readable storage media; a processing system operatively coupled with the one or more computer readable storage media; and program instructions stored on the one or more computer readable storage media that, when read and executed by the processing system, direct the processing system to at least: in a user interface to an application, surface a representation of an organization graph associated with a user; in response to a selection of a node in the organization graph, identify from a set of groups associated with the organization graph a subset of groups to suggest to the user; and in the user interface, surface group suggestions representative of the subset of groups.

Example 2. The computing apparatus of Example 1 wherein the program instructions further direct the processing system to identify content associated with the node and to surface content suggestions in the user interface representative of the content.

Example 3. The computing apparatus of Examples 1-2 wherein the organization graph comprises a set of nodes that includes the selected node and wherein the set of groups comprises only those groups associated with a subset of nodes in the set of nodes.

Example 4. The computing apparatus of Examples 1-3 wherein each of the set of nodes represents one of at least a person and a document.

Example 5. The computing apparatus of Examples 1-4 wherein each group of the set of groups comprises an email group.

Example 6. The computing apparatus of Examples 1-5 wherein the subset of nodes comprises only the selected node.

Example 7. The computing apparatus of Examples 1-6 wherein the subset of nodes comprises multiple nodes, including the selected node.

Example 8. A method for driving group associations comprising: surfacing a representation of an organization graph associated with a user in a user interface to an application; identifying, from a set of groups associated with the organization graph, a subset of groups to suggest to the user; and surfacing group suggestions representative of the subset of groups in the user interface to the application.

Example 9. The method of Example 8 further comprising identifying content associated with the subset of groups and surfacing content suggestions in the user interface representative of the content.

Example 10. The method of Examples 8-9 wherein the organization graph comprises a set of nodes and wherein the set of groups comprises only those groups associated with a subset of nodes in the set of nodes.

Example 11. The method of Examples 8-10 wherein each node of the set of nodes represents one of at least a person and a document.

Example 12. The method of Examples 8-11 wherein each group of the set of groups comprises an email group.

Example 13. The method of Examples 8-12 wherein the subset of nodes comprises only a single node.

Example 14. The method of Examples 8-13 wherein the subset of nodes comprises multiple nodes.

Example 15. A method of operating an application comprising: surfacing a representation of an organization graph associated with a user in a user interface to the application; receiving group suggestions representative of a subset of email groups selected from a set of email groups associated with the organization graph; and surfacing the group suggestions in the user interface to the application.

Example 16. The method of Example 15 further comprising and surfacing content suggestions in the user interface representative of content associated with the subset of email groups.

Example 17. The method of Examples 15-16 wherein the organization graph comprises a set of nodes and wherein the set of email groups comprises only those groups associated with a subset of nodes in the set of nodes.

Example 18. The method of Examples 15-17 wherein each node of the set of nodes represents one of at least a person and a document.

Example 19. The method of Examples 15-18 wherein the subset of nodes comprises only a single node.

Example 20. The method of Examples 15-19 wherein the subset of nodes comprises multiple nodes.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media; and
program instructions stored on the one or more computer readable storage media that, when read and executed by the processing system, direct the processing system to at least:
in a user interface to an application, surface a representation of an organization graph associated with a user;
in response to a selection of a node in the organization graph, identify from a set of groups associated with the organization graph a subset of groups to suggest to the user; and
in the user interface, surface group suggestions representative of the subset of groups.

2. The computing apparatus of claim 1 wherein the program instructions further direct the processing system to identify content associated with the node and to surface content suggestions in the user interface representative of the content.

3. The computing apparatus of claim 1 wherein the organization graph comprises a set of nodes that includes the selected node and wherein the set of groups comprises only those groups associated with a subset of nodes in the set of nodes.

4. The computing apparatus of claim 3 wherein each of the set of nodes represents one of at least a person and a document.

5. The computing apparatus of claim 3 wherein each group of the set of groups comprises an email group.

6. The computing apparatus of claim 3 wherein the subset of nodes comprises only the selected node.

7. The computing apparatus of claim 3 wherein the subset of nodes comprises multiple nodes, including the selected node.

8. A method for driving group associations comprising:
surfacing a representation of an organization graph associated with a user in a user interface to an application;
identifying, from a set of groups associated with the organization graph, a subset of groups to suggest to the user; and
surfacing group suggestions representative of the subset of groups in the user interface to the application.

9. The method of claim 8 further comprising identifying content associated with the subset of groups and surfacing content suggestions in the user interface representative of the content.

10. The method of claim 8 wherein the organization graph comprises a set of nodes and wherein the set of groups comprises only those groups associated with a subset of nodes in the set of nodes.

11. The method of claim 10 wherein each node of the set of nodes represents one of at least a person and a document.

12. The method of claim 10 wherein each group of the set of groups comprises an email group.

13. The method of claim 10 wherein the subset of nodes comprises only a single node.

14. The method of claim 10 wherein the subset of nodes comprises multiple nodes.

15. A method of operating an application comprising:
surfacing a representation of an organization graph associated with a user in a user interface to the application;
receiving group suggestions representative of a subset of email groups selected from a set of email groups associated with the organization graph; and
surfacing the group suggestions in the user interface to the application.

16. The method of claim 15 further comprising and surfacing content suggestions in the user interface representative of content associated with the subset of email groups.

17. The method of claim 15 wherein the organization graph comprises a set of nodes and wherein the set of email groups comprises only those groups associated with a subset of nodes in the set of nodes.

18. The method of claim 17 wherein each node of the set of nodes represents one of at least a person and a document.

19. The method of claim 17 wherein the subset of nodes comprises only a single node.

20. The method of claim 17 wherein the subset of nodes comprises multiple nodes.
